(19) United States
(12) Patent Application Publication
(10) Pub. No.: US 2003/0027118 A1
(43) Pub. Date: Feb. 6, 2003

(54) Analysis system for monitoring training during rehabilitation

(76) Inventors: Klaus Abraham-Fuchs, Erlangen (DE); Kai-Uwe Schmidt, Erlangen (DE); Uwe Eisermann, Erlangen (DE)

Correspondence Address: YOUNG & THOMPSON, 745 SOUTH 23RD STREET 2ND FLOOR, ARLINGTON, VA, 22202

(21) Appl. No.: 09/996,701

(22) Filed: Nov. 30, 2001

(30) Foreign Application Priority Data
Jul. 27, 2001 (DE) 10136759.7

(51) Int. Cl. G09B 19/00

(52) U.S. Cl. 434/258

(57) ABSTRACT

An analysis system for monitoring and optimizing a training program to be carried out by a patient without constant supervision, with computer-assisted measuring modules fitted on the training apparatuses and/or on the patient and/or in a patient PC for recording the activity and/or the sequence of movements of the patient to derive characteristic variables for patient compliance.

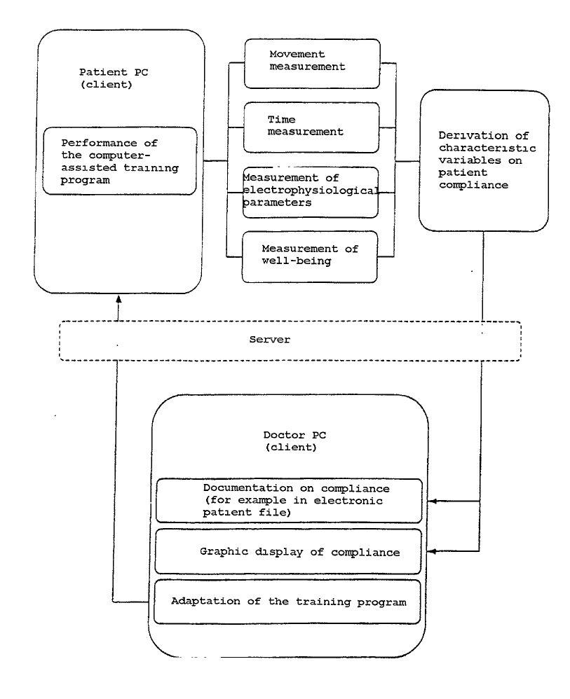

The invention relates to an analysis system for monitoring and optimizing a training program to be carried out by a patient without constant supervision.

A major component of rehabilitation is the self-training of the patient, that is to say the training undertaken by the patient under his own responsibility and generally without active supervision by the doctor or therapist to improve capabilities relevant to rehabilitation. Dependent on diagnosis (diagnoses) and indication (indications), this training involves a training of motorial capabilities (for example power, mobility, balance) and/or cognitive capabilities (attentiveness, memory). For instance, in orthopedic rehabilitation (for example after bone fractures) and in cardiological rehabilitation (for example after cardiac infarction), motorial capabilities are primarily trained. In neurological rehabilitation (for example after cerebral infarction/hemorrhage, that is to say a “stroke”), on the other hand, cognitive capabilities are primarily trained. If motorial and cognitive functions are impaired, a combined training (training of motorial and cognitive capabilities) is indicated. One area in which this form of training is favored is geriatric rehabilitation (for example in the case of Alzheimer's disease) and also in neurological rehabilitation for complex traumas (for example a stroke with hemiplegia).

In the areas of rehabilitation referred to, increasing use is being made today of innovative computer-based concepts, for example the “HealthMan Physio Assistant” prototype developed by Siemens AG for orthopedic rehabilitation. The Physio Assistant is a computer system with training and therapy monitoring functions and also information and communication functions. The system comprises at least one expert terminal (“expert-client”) for the doctor or therapist, a central or remote server and, depending on the architecture, one or more patient terminals (“patient-client/s”). The expert client (PC) of the Physio Assistant is used by the medical supervisor to produce individually optimized training programs for the patient. These are transferred to the patient-client (PC) by telematic means. This terminal carries out the initial processing of the targets stipulated by the doctor or therapist and offers the patient multimedia real-time training programs.

Decisive for the success of the training is the “compliance” of the patient, that is to say adherence to the training prescribed, taking into consideration the stipulated exertion factors adjusted to the conditions within the individual of a qualitative nature (for example accuracy of performance) and quantitative nature (for example duration and frequency of performance) (cf. Weineck 1996, p. 24). To be able to improve the compliance of the patient by interaction with the patient and adaptation of the training, the doctor or therapist must know

| | |
|---|---|
| when and for how long the | (time aspect, |
| patient has been training | objective) |
| whether the patient has been | (performance aspect, |
| training in accordance with the | objective) |
| targets | |
| how the patient feels and | (well-being aspect, |
| assesses himself | subjective). |

The invention has the aim of measuring the compliance of the patient specifically in the context of carrying out therapeutic training programs. By way of example, these training programs comprise for instance physiotherapeutic exercises (movement training, power training etc.), neurological exercises (training of coordination disorders, speech disorders) or cardiological exercises (circulatory training).

When carrying out prescribed medical exercises, examples of possible measured variables for the compliance of the patient are:

the fact that the patient carries out an exercise at all (for example measured by switching on an appliance, such as a computer, bicycle ergometer, measuring signals of sensors on the body of the patient, establishing the duration and frequency of a training program being called up in the patient's computer etc.)

the duration for which it is carried out (period switched on, duration of the flow of data generated during training etc., for example including from movement sensors on the body of the patient or on the training apparatus)

measurement of the physical movement of the patient (does he have sensors for measuring movement in operation in the first place? Do the sensor signals indicate that the correct part of the body is being moved?. that the correct part of the body is being moved in the way expected?)

measurement of physiological variables which are changed by carrying out the exercises (for example heart rate, blood pressure, oxygen saturation, COhd 2 in the air exhaled etc.)

measurement of the well-being of the patient, typically recorded by entry in a “medical patient diary” (for example state of exhaustion, pain, sleeplessness etc.)

Depending on the quality of the sensor equipment used and expenditure on measuring instruments, the recorded measured values for quantifying compliance may be meaningful in three quality stages:

are exercises being performed at all, and with which duration and frequency?

are the exercises being performed in such a way that the expected benefit of the exercise can be achieved at all (correct part of the body? any exertion of the body detectable? etc.)

are the exercises being performed correctly or incorrectly within preset limit values? (for example extent, angle etc. of a physical movement, rise in heart rate at least by x, but not more than y etc.)

Until now, it was only by observation and verbal questioning that the doctor or therapist was able to record these aspects and change the training in a way corresponding to the distinctive features. This procedure is time-intensive and cannot be implemented for every patient and every training unit. The device to be described hereafter offers the doctor or therapist the possibility of an extensive analysis of the training of the patient and the compliance of the latter, without having to observe and verbally question the patient. It is consequently ideally suited in general for many forms of telemedical supervision and specifically for the Physio Assistant concept outlined.

Training and compliance analyses are not to be equated with checks to monitor how therapy is proceeding. Devices developed for checking how therapy is proceeding are used to record changes of selected functions in the course of therapy (for example changing of the gait pattern during the course of inpatient rehabilitation). On the other hand, a device for training or compliance analysis is used to “measure” the training-specific aspects mentioned above and inform the doctor or therapist whether and how the patient has been training.

All this information for the analysis of the training and compliance of the patient, with subsequently taken measures to improve compliance, could until now only take place by direct observation and questioning by a doctor or therapist.

U.S. Pat. No. 6,210,301 already discloses an arrangement in which sensors on the body (acceleration, angle, pressure, shearing forces) record the patterns of movements of the patient, compare them with stipulated values and give the user biofeedback during the exercise on the extent to which it is being carried out correctly.

DE 198 46 982 A1 already describes a method and system for monitoring the posture of a user on a training apparatus using purely kinematic sensors on the user or on parts of the training apparatus. Here, too, the only concern is to monitor movements to ascertain whether the user is operating the apparatus correctly. Both of the above patents are aimed at biofeedback concerning the correct performance of sequences of movements within physiological training, but not with measurement of compliance for assessment for outside third parties, and also only cover a few aspects of movement but not frequently necessary measured variables such as time recording, physiological parameters or states of well-being.

The invention is therefore based on the object of providing an analysis system which makes it possible for training to be monitored automatically without individual questioning by a doctor or therapist.

To achieve this object, an analysis system of the type stated at the beginning is characterized according to the invention by computer-assisted measuring modules fitted on the training apparatuses and/or on the patient and/or in a patient PC for recording the activity and/or the sequence of movements of the patient to derive characteristic variables for patient compliance. Training apparatus is to be understood here—in the case of training of the cognitive capabilities—as including a PC or computer with an integrated measuring module.

The measuring modules comprise, as the first type, what are known as event modules for determining time-related parameters, such as for example the overall duration of the training (gross and net) and the duration of the individual exercises. The event module can be activated automatically or manually by the patient.

In addition, movement modules for determining the movements performed by the patient are to be provided, which is relevant of course only for the training of motorial capabilities. The measurements supply information on whether the patient has moved at all, whether he has moved the correct part of the body, for example target: move left leg—patient moves left leg: target achieved. In addition, the measurement can supply information on whether he has moved the part of the body in accordance with the target, for example stretch left leg right out.

A third type of measuring modules, significant for the analysis system according to the invention, are measuring modules for electrophysiological parameters, such as for example heart rate, blood pressure, temperature, potential differences (for example ECG, EMG) and potential fluctuations (for example EEG). By analogy with the movement measuring module, it is recorded for selected parameters whether they change at all (rise in heart rate at the beginning of training), whether they change in such a way that performance of training can be concluded (for example alternating rise and fall in heart rate) or whether they change in such a way that performance of the stipulated training can be concluded (for example rise and fall in heart rate in accordance with exertion targets, such as for example the intensity of exertion, duration of exertion and concentration of exertion).

Finally, in a further embodiment of the invention, the use of a well-being measuring module may also be provided, providing questions which have to be answered by the patient at defined points in time, for example on how the training is proceeding, on the amount of exertion and on well-being. Such questionnaires may be devised on the basis of known quality-of-life questionnaires.

The doctor or therapist decides which of the four modules is to be used for the later analysis of compliance or of a training unit. The event measuring module and/or movement module and/or measuring module for electrophysiological parameters and/or the well-being measuring module.

The measuring modules referred to may be directly integrated into a patient PC—unless pure movement signals on the training apparatus or measuring signals from sensors on the body of the patient are concerned—that is to say the event modules and/or well-being modules specifically may be component parts of software which can be run on a patient PC, it being possible for such software also to include the training program or programs which are made available by the doctor to the patient on the basis of the doctor's assessment of compliance. The patient either receives a floppy disk or the respective software is transferred to his PC online with the training program and the event or well-being modules by the doctor or the supervising center.

An analysis system according to the invention is preferably integrated into a telemedical treatment system, with a central or remote server with an access terminal for the patient and the doctor or therapist.

In a further embodiment of the invention, the derived characteristic variables for compliance can not only be transferred to a central server, or the doctor PC, but also be stored in an electronic patient file together with other health data on the patient.

In this case, it has also proven to be expedient for the derived characteristic variables for compliance to be graphically displayed, in particular in their variation over time or in a comparison between the compliance with respect to different training units.

If appropriate, medically indicated changes of the training program can be advantageously derived from the characteristic variables for compliance, it being possible for the changed training program to be sent directly to the patient by electronic means.

Finally, it is also within the scope of the invention to derive an alarm signal in the case of poor compliance on the part of the patient and pass it directly on to the doctor PC.

Further advantages, features and details of the invention emerge from the following description of an exemplary embodiment and on the basis of the drawing, which shows a schematic flow diagram of an analysis system according to the invention as part of a telemedical treatment system.

Computer assistance of the various measuring modules for the movement measurement, time measurement, measurement of electrophysiological parameters and measurement of well-being takes place via the patient PC. The time-related parameters may in this case be measured by means of a clock (switching on of the time measurement after logging on at the client terminal and switching off of the time measurement after switching off), by means of mouse clicks or by means of the training apparatuses themselves (switching on and off of the time measurement in analogy with the switching on and off of training apparatuses). A movement can be measured by means of the movement measuring module as follows: optoelectronic sensors (for example camera, WebCam), acceleration sensors, angle measuring sensors, pressure sensors or strain sensors.

For measuring the electrophysiological parameters, heart rate measuring instruments (for example wrist band, breast belt), blood-pressure measuring instruments, thermometers, ECG equipment and EEG equipment may be used.

From the measurement data of the various measuring modules, characteristic variables on patient compliance are derived and, after remote data transmission to a server, are graphically preprocessed on the doctor PC. It is important here in particular that the characteristic variables are clearly displayed in their variation over time throughout the entire supervision, to allow development trends to be presented.

The doctor assesses the result and sends the patient recommendations or a modified training program.

It is to be seen as a decisive advantage of this solution that the doctor or therapist receives the central information concerning the training without having to be present himself. Assuming computer-assisted evaluation, he can in this way supervise more patients per unit of time and treat them in an individually optimized way. For the patient, the optimum treatment can be seen as an advantage. In addition, the patient can train independently of personnel or time constraints. Moreover, it is conceivable for such remote-monitored training to be used for patients who have been partly or fully discharged, allowing inpatient treatment times to be shortened and costs for rehabilitation to be reduced.

1. An analysis system for monitoring and optimizing a training program to be carried out by a patient without constant supervision, characterized by computer-assisted measuring modules fitted on the training apparatuses and/or on the patient and/or in a patient PC for recording the activity and/or the sequence of movements of the patient to derive characteristic variables for patient compliance.

2. The analysis system as claimed in claim 1, characterized in that the measuring modules comprise event modules for determining time-related parameters.

3. The analysis system as claimed in claim 1 or 2, characterized in that the measuring modules comprise movement modules for determining the movements performed by the patient.

4. The analysis system as claimed in one of claims 1 to 3, characterized by measuring modules for recording the electrophysiological parameters of the patient.

5. The analysis system as claimed in one of claims 1 to 4, characterized by a well-being module for questioning the patient on subjective aspects of the training such as the training sequence, amount of exertion, current well-being or the like.

6. The analysis system as claimed in one of claims 1 to 5, characterized in that it is integrated into a telemedical treatment system.

7. The analysis system as claimed in claim 5, characterized by a central or remote server with access terminals for the patient and the doctor or therapist.

8. The analysis system as claimed in one of claims 1 to 7, characterized in that the derived characteristic variables for compliance are transferred to a central server or the doctor PC.

9. The analysis system as claimed in one of claims 1 to 8, characterized in that the derived characteristic variables for compliance are stored in an electronic patient file together with other health data on the patient.

10. The analysis system as claimed in one of claims 1 to 9, characterized in that the derived characteristic variables for compliance are graphically displayed, in particular in their variation over time or in a comparison between the compliance with respect to different training units.

11. The analysis system as claimed in one of claims 1 to 10, characterized in that, if appropriate, medically indicated changes of the training program are derived from the characteristic variables for compliance.

12. The analysis system as claimed in one of claims 1 to 11, characterized in that the changed training program is sent to the patient PC by electronic means.

13. The analysis system as claimed in one of claims 1 to 12, characterized in that an alarm signal is derived in the case of poor compliance on the part of the patient and this alarm signal is passed on to the doctor PC.

14. The analysis system as claimed in one of claims 1 to 13, characterized in that the event modules and/or well-being modules are component parts of software which can be run on a patient PC.

15. The analysis system as claimed in claim 14, characterized in that the software also contains the training program.
